(19) United States
(12) Patent Application Publication
(10) Pub. No.: US 2008/0296395 A1
(43) Pub. Date: Dec. 4, 2008

(54) Fuel Extraction System for an Auxiliary Heating Unit

(75) Inventors: Nils Elm, Krailling (DE); Karsten Kohler, Munich (DE)

Correspondence Address: DICKINSON WRIGHT PLLC, 1901 L. STREET NW, SUITE 800, WASHINGTON, DC, 20036, US

(73) Assignee: WEBASTO AG, Strockdorf (DD)

(21) Appl. No.: 12/158,630

(22) PCT Filed: Dec. 19, 2006
(86) PCT No.: PCT/DE1006/002276

§ 371 Date: Aug. 12, 2008

(30) Foreign Application Priority Data
Dec. 22, 2005 (DE) 10 2005 061 604.6

(51) Int. Cl. B60H 1/22; B60K 15/00; F23K 5/00

(52) U.S. Cl. 237/32

(57) ABSTRACT

The invention relates to a fuel extraction system for an auxiliary heating unit for extracting fuel from a fuel tank (10, 12) of a motor vehicle, wherein the fuel extraction system has a collecting tank (30) which is held in the fuel tank (10, 12) and is assigned exclusively to the auxiliary heating unit.

The invention relates to a fuel extraction system for an auxiliary heating unit for extracting fuel from a fuel tank of a motor vehicle.

Furthermore, the invention relates to an auxiliary heating unit and a motor vehicle having such a fuel extraction system for an auxiliary heating unit.

Furthermore, the invention relates to a method for extracting fuel for an auxiliary heating unit for the extraction of fuel from a fuel tank of a motor vehicle.

In the past, a pipe was used to extract the fuel for auxiliary heating units of the combustion type from a fuel tank of a motor vehicle. However, this entails the disadvantage that, particularly when there is a low filling level of the fuel in the fuel tank, the fuel can slosh away from an intake pipe. Furthermore, there is the risk of bubbles or foams which are contained in the fuel and are predominantly located on the surface of the fuel being sucked into the intake pipe. In order to supply fuel to the internal combustion engine of the motor vehicle, the fuel is extracted from the fuel tank by means of a built-in surge pot. These surge pots are arranged on the bottom of the fuel tank and are filled using a suction jet pump as a result of the fuel flowing over the upper edge of the surge pot, through an opening in the bottom of the surge pot which is provided with a valve. The surge pot supplies fuel even if the fuel in the tank sloshes to and fro. This ensures that fuel is present in the intake pipe for the fuel supply of the internal combustion engine in all driving situations.

A significant improvement in the operation of the auxiliary heating unit is achieved by virtue of the fact that the fuel is extracted from the surge pot since here the fuel sloshes away less. However, the fuel in the surge pot frequently also contains bubbles or is foamed. Furthermore, the fuel can also slosh in the surge pot, albeit to a lesser degree than in the fuel tank. The bubbles and foams in the fuel are sucked in by a metering pump of the auxiliary heating unit. Furthermore, air is sucked in if the fuel sloshes away from the intake pipe. Combustion heating devices react very sensitively to bubbles in the fuel supply and they can bring about unclean burning behavior. Relatively large bubbles even cause the flame to go out, which causes troublesome fumes to be generated.

The object of the present invention is therefore to develop the generic fuel extraction system for an auxiliary heating unit, the generic auxiliary heating unit, the generic motor vehicle and the generic method in such a way that an optimized supply of fuel to an auxiliary heating unit can be ensured.

This object is achieved by means of the features of the independent claims.

Advantageous refinements and developments of the invention emerge from the dependent claims.

The fuel extraction system according to the invention for an auxiliary heating unit is based on the generic prior art in that the fuel extraction system has a collecting container which is held in the fuel tank and is assigned exclusively to the auxiliary heating unit. Such a design of the fuel extraction system provides a fuel collecting space in which sloshing of the fuel can be minimized. As a result of the measure according to which the collecting container is assigned exclusively to the auxiliary heating unit, said collecting container can be specially tailored to the requirements for the auxiliary heating unit. Since an auxiliary heating unit consumes less fuel than an internal combustion engine, the collecting container, which is assigned exclusively to the auxiliary heating unit, can be made smaller than conventional surge pots for supplying fuel to internal combustion engines. The collecting container is preferably significantly smaller than previous surge pots, with the result that sloshing of the fuel can be greatly minimized. If the collecting container is assigned exclusively to the auxiliary heating unit, this has the further advantage that in the stationary-state heating mode a situation does not occur in which the auxiliary heating unit burns the fuel in the collecting container when the fuel tank is virtually empty, and as a result of the virtually empty fuel tank, fuel does not flow on into the collecting container with the result that there is no longer any fuel available in the same collecting container to start the internal combustion engine.

The fuel extraction system according to the invention can be developed by virtue of the fact that the collecting container is held in a surge pot which is located in the fuel tank. By virtue of the fact that the collecting container is held in the surge pot, the collecting container is necessarily smaller than the surge pot, as a result of which the fuel in the collecting container sloshes less than in the surge pot. The sloshing of the fuel is therefore firstly reduced by the surge pot compared to the fuel tank, and is then reduced further by the collecting container compared to the surge pot. As a result, the fuel can be extracted with few bubbles and little foam. This improved extraction of fuel provides a significantly improved burning behavior of the auxiliary heating unit.

The fuel extraction system according to the invention can be advantageously developed by virtue of the fact that the fuel extraction system has an extraction line for sucking in the fuel, with the sucking end of the extraction line being surrounded by the collecting container which is at least partially open at the top. As a result of this development, fuel runs over the upper edge and into the collecting container. The sucking end of the extraction line is accordingly located below the filling edge of the collecting container. As a result, bubbles and foam which find their way into the collecting container rise owing to the force of gravity so that these bubbles and the foam are located at the filling edge. The fuel which is sucked in underneath the filling edge is therefore low in bubbles and foam.

In addition, the fuel extraction system according to the invention can be embodied in such a way that an upper opening of the collecting container is provided with a lid which has holes. This lid can make it more difficult for the collecting container to be emptied as a result of sloshing.

Furthermore, the fuel extraction system according to the invention can be embodied in such a way that an upper opening in the collecting container is covered with a screen. This screen enables bubbles and/or dirt to be deflected.

Furthermore, the fuel extraction system according to the invention can be developed in such a way that the collecting container is connected to the surge pot. This development allows the collecting container to be already constructed in the surge pot when the surge pot is manufactured, as a result of which it is ensured that the fuel extraction system can easily be mounted.

Furthermore, the fuel extraction system according to the invention can be developed in such a way that the collecting container is held in the surge pot without contact with the surge pot. The distance between the bottom of a fuel tank and the top of a fuel tank changes, inter alia, as a function of the filling level in the fuel tank, the pressure in the tank and the temperature. Since fuel is generally extracted via the top of the fuel tank, and the surge pot is generally located on the bottom of the fuel tank, it is advantageous if the collecting container can follow this changed distance. Since the collecting container is held in a contact-free fashion in the surge pot, the collecting container can be raised and lowered with the change in the distance between the bottom of the fuel tank and the top of the fuel tank, with the result that the fuel extraction system is not damaged.

Alternatively, the fuel extraction system can also be embodied in such a way that the extraction line has a flexible section. This flexible section allows the change which has just been described in the distance between the bottom of a fuel tank and the top of a fuel tank to be compensated.

The advantages described above are obtained in a surprising way for the auxiliary heating unit according to the invention, the motor vehicle according to the invention and the method according to the invention.

Preferred embodiments of the invention are explained below by way of example with reference to the figures, of which:

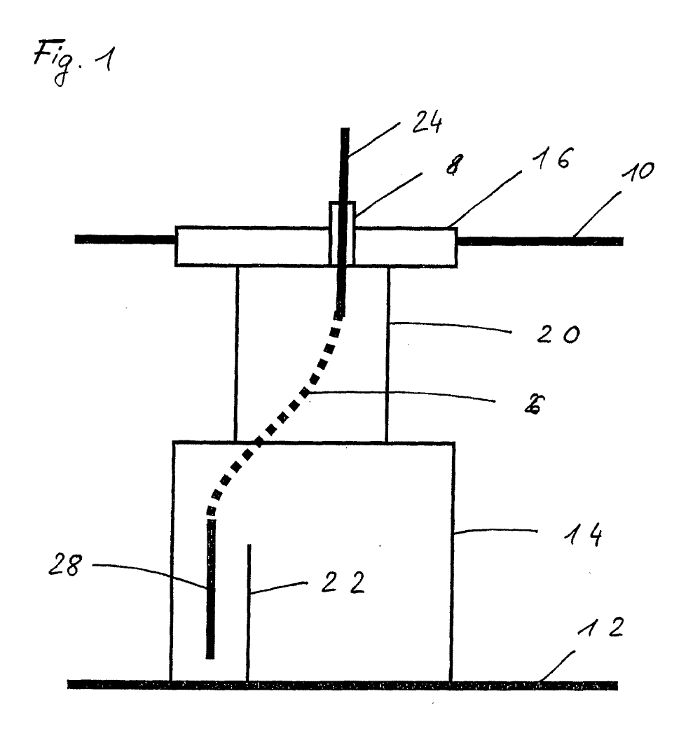

FIG. 1 shows a first exemplary embodiment of the fuel extraction system according to the invention, and

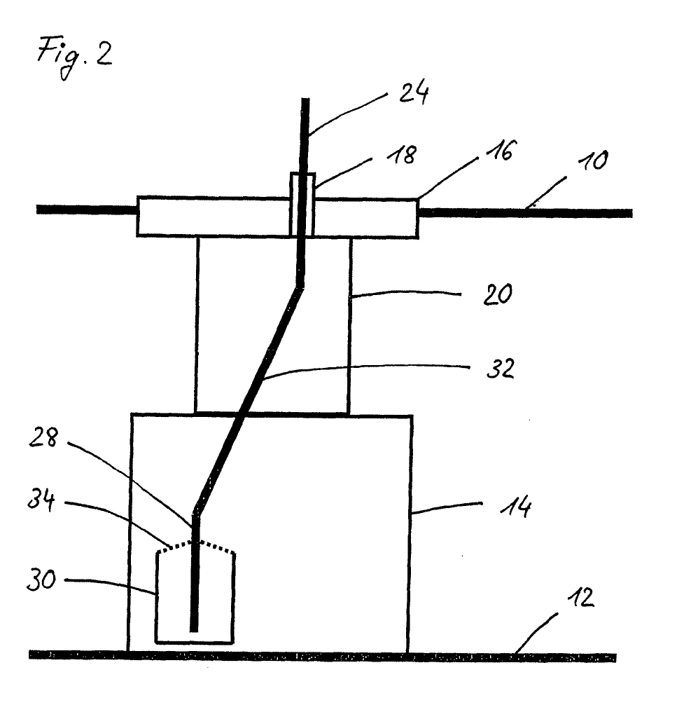

FIG. 2 shows a second exemplary embodiment of the fuel extraction system according to the invention.

FIG. 1 shows a first exemplary embodiment of the fuel extraction system according to the invention. A detail of a fuel tank is illustrated, which detail comprises the top 10 of a fuel tank and the bottom 12 of a fuel tank.

A surge pot 14 is arranged on the bottom 12 of the fuel tank. A flat-cylindrical surge pot fitting 16 is inserted into the top 10 of the fuel tank on the same vertical line on which the surge pot 14 is located. An opening, which is provided with an extraction connector piece 18, is provided in the surge pot fitting 16. The surge pot 14 is a cylindrical container which is open at the top. The side of the surge pot 14 which faces the top 10 of the fuel tank is provided, for example, with a lid which has large holes, in order to permit fuel to run over the upper edge when the surge pot is full. A connecting element 20, which is connected to the surge pot fitting 16 and the surge pot 14 or supported against it, is arranged between the lid of the surge pot 14 and the surge pot fitting 16. Instead of the above-mentioned lid on the upper edge of the surge pot 14, it is also possible to provide webs which permit the surge pot 14 to be supported against the connecting element 20. The surge pot 14 is connected to the bottom 12 of the fuel tank and is embodied in one piece with it or is held by means of the surge pot fitting 16 or pressed against the bottom 12 of the fuel tank. A collecting container 22 is arranged in the surge pot 14. This collecting container 22 may be securely connected as a separate component to the surge pot 14 or may be a component of the surge pot 14 by virtue of the fact that it is injection molded or cast into the surge pot. The secure connection can be implemented, for example, by means of a plug-type connection or screwed connection. The collecting container 22 is preferably cylindrical and can be completely open at the top, as illustrated in FIG. 1. Furthermore, the collecting container 22 may be covered with a screen (not illustrated) or a lid which is provided with openings. The collecting container 22 is significantly smaller than the surge pot 14. The bottom of the collecting container 22 is arranged on the bottom of the surge pot 14. Alternatively, the bottom of the collecting container 22 is formed by the bottom of the surge pot 14, or both the bottom of the surge pot 14 and the bottom of the collecting container 22 are formed by the bottom 12 of the fuel tank. In order to extract fuel, an extraction pipe 24, which projects somewhat into the connecting element 20, is inserted into the extraction connector piece 18. A flexible hose 26, which leads almost as far as the upper edge of the collecting container 22 in the surge pot 14, adjoins the extraction pipe 24 in the connecting element 20. An intake pipe 28, whose length corresponds approximately to the height of the collecting container 22, adjoins this end of the flexible hose 26. This intake pipe 28 extends into the collecting container 22 and ends in the vicinity of the bottom of the collecting container 22. The extraction pipe 24, the flexible hose 26 and the intake pipe 28 therefore form an extraction line which is embodied as a single-piece, tube-like element with a flexible middle part. Alternatively, the extraction pipe 24, the flexible hose 26 and the intake pipe 28 could be individual elements which are securely connected to one another, for example by fitting the ends of the flexible hose 26 onto the respective ends of the extraction pipe 24 and of the intake pipe 28. The intake pipe 28 is either connected to the collecting container 22 or to the surge pot 14. This connection can be implemented, for example, by means of a clamp (not illustrated) which is arranged on the surge pot 14 or on the collecting container 22 and clamps the intake pipe 28 tight in the position described above. Furthermore, a plate, which has a central opening whose diameter corresponds to that of the intake pipe 28, could be pressed into the upper opening in the collecting container 22 so that after insertion into the central opening the intake pipe 28 is secured relative to the collecting container 22, and in which case this plate has bores radially outside this central opening, which bores permit the collecting container 22 to be filled with fuel. The distance between the top 10 of the fuel tank and the bottom 12 of the fuel tank changes, inter alia, as a function of the filling level of the fuel tank, the pressure in the fuel tank and the temperature. For this reason, the surge pot fitting 16 changes its distance from the surge pot 14. This change in the distance therefore acts on the distance between the extraction pipe 24 and intake pipe 28 since the extraction pipe 24 is connected to the surge pot fitting 16, and the intake pipe 28 is connected to the surge pot 14 or the collecting container 22. This change in distance is counteracted by the flexible hose 26 which compensates for a change in the distance by means of its flexibility.

During operation, there is fuel in the fuel tank which sloshes to and fro as a result of the movement of the motor vehicle. In this context, the surge pot 14 is filled as a result of the fuel overflowing over the upper edge of the surge pot 14 if the surge pot 14 is open at the top or the upper opening of the surge pot 14 is provided with a grille. Alternatively or additionally, the surge pot 14 can also be filled by means of an opening in the base of the surge pot 14 which is provided with a valve or by means of a suction jet pump. The collecting container 22 is filled by virtue of the fact that the fuel which is then located in the surge pot 14 runs in over the upper edge of the collecting container 22. The fuel which is located in the collecting container 22 is sucked in by means of a metering pump (not illustrated) which is connected to the extraction pipe 24 which leads out of the extraction connector 18, and said fuel is fed to an auxiliary heating unit (not illustrated). In this context, the fuel is sucked out in the vicinity of the bottom of the collecting container 22, which ensures that fuel is always present at the intake pipe 28. Bubbles or foam in the fuel rise owing to the force of gravity so that fuel which is low in bubbles or foam is present at the bottom of the collecting container 22. Even if the fuel sloshes in the surge pot 14, the collecting container 22 remains largely filled owing to its shape and its relatively small diameter.

The following is to be noted in terms of the determination of the height of the collecting container 22. The collecting container 22 should be at least of such a height that even when the fuel sloshes to the greatest extent in the surge pot 14 said collecting container 22 is not emptied. Furthermore, the collecting container 22 should be at least of such a height that bubbles which pass over the upper edge do not arrive at the bottom of the collecting container 22 since they have sufficient space to rise. Furthermore, the maximum height of the collecting container 22 should be selected such that it is sufficiently filled as a result of the fuel running over the upper edge of the collecting container 22. In the stationary heating mode, the surge pot 14 can be emptied if it is not filled by a vehicle fuel pump to a sufficient degree. The upper edge of the collecting container 22 corresponds to the height up to which the surge pot 14 can be emptied as a result of the extraction of fuel for the auxiliary heating unit. This height should be selected such that even without filling sufficient fuel is available for operation of the vehicle. These requirements mentioned above are met with a height of the collecting container 22 of approximately 4 cm.

FIG. 2 shows a secondary exemplary embodiment of the fuel extraction system according to the invention. Only elements which differ from the first exemplary embodiment are described in conjunction with the second exemplary embodiment which is illustrated in FIG. 2. In contrast to the collecting container 22 of the first exemplary embodiment, the collecting container 30 of the second exemplary embodiment is not connected to the surge pot 14. The collecting container 30 of the second exemplary embodiment is held in the surge pot 14 and positioned in it in a freely floating fashion without contact with the surge pot 14. Instead of the flexible hose 26 of the first exemplary embodiment, a rigid connecting pipe 32 is provided in the second exemplary embodiment. The extraction line is accordingly formed by the extraction pipe 24 which is inserted into the extraction connector 18, the connecting pipe 32 which is connected to the extraction pipe 24 and the intake pipe 28 which is connected to the connecting pipe. The extraction pipe 24, the connecting pipe 32 and the intake pipe 28 may be embodied in one piece or these pipes can be coupled to one another by means of a plug-type connection. The intake pipe 28 projects into the collecting container 30, with the result that the open end of the intake pipe 30 is positioned in the vicinity of the bottom of the collecting container 30. The collecting container 30 can, as described in conjunction with the first exemplary embodiment, be open at the top, be covered with a screen or be covered with a lid which is provided with openings. Furthermore, the collecting container 30 is connected to the intake pipe 28 by means of an attachment element 34. This attachment element 34 can be implemented by means of a ring which is pressed onto the intake pipe 28 and from which rigid wires extend to the upper edge of the collecting container 30. These wires are integrally connected to the upper edge of the collecting container 30. When the surge pot 14 is completely mounted, the collecting container 22 can be subsequently installed with this attachment element 34. If the distance between the surge pot fitting 16 and surge pot 14 changes, as described in conjunction with the first exemplary embodiment, the collecting container 30 which is connected to the extraction line and therefore to the surge pot fitting 16 is raised or lowered with respect to the bottom of the surge pot. In terms of the dimensions of the collecting container 30, the same applies as has been stated with regard to the collecting container 22 in the first exemplary embodiment. In the second exemplary embodiment, the rest of the operation of extraction of fuel corresponds to that in the first exemplary embodiment.

It is to be noted that the surge pot 14 and the surge pot fitting 16 do not need to be cylindrical and can also be of a different geometric shape, such as for example of a polygonal shape.

Likewise, the collecting container 22 can have any geometric, vessel-like shape, such as, for example, that of a polygon in plan view. Furthermore, in the first exemplary embodiment the collecting container 22 can be formed by two walls which extend inward from the inner wall of the surge pot 14 and meet so that a vessel which is open at the top is produced, said vessel having a triangular shape in plan view, with one side of the triangle being formed by the outer edge of the surge pot 14 and therefore being curved.

Furthermore, it is to be noted that although in the first and second exemplary embodiments the collecting container 22, 30 is always arranged in a surge pot 14, the invention is not restricted to this. For example, the fuel extraction system according to the invention can also be embodied without a surge pot 14.

The features of the invention which are disclosed in the present description, in the drawings and in the claims may be essential for the implementation of the invention, either individually or in any desired combination.

### List of Reference Numerals

10 Top of fuel tank
12 Bottom of fuel tank
14 Surge pot
16 Surge pot fitting
Extraction connector
Connecting element
Collecting container
Extraction pipe
Flexible hose
Intake pipe
Collecting container
Connecting pipe
Attachment element

1. A fuel extraction system for an auxiliary heating unit for extracting fuel from a fuel tank of a motor vehicle, characterized in that the fuel extraction system has a collecting container which is held in the fuel tank and is assigned exclusively to the auxiliary heating unit.

2. The fuel extraction system of claim 1, characterized in that the collecting container is held in a surge pot which is located in the fuel tank.

3. The fuel extraction system of claim 1, characterized in that the fuel extraction system has an extraction line for sucking in the fuel, wherein the sucking end of the extraction line is surrounded by the collecting container which is at least partially open at the top.

4. The fuel extraction system of claim 1, characterized in that an upper opening of the collecting container is provided with a lid which has holes.

5. The fuel extraction system of claim 1, characterized in that an upper opening in the collecting container is covered with a screen.

6. The fuel extraction system of claim 2, characterized in that the collecting container is connected to the surge pot.

7. The fuel extraction system of claim 2, characterized in that the collecting container is held in the surge pot without being in contact with the surge pot.

8. The fuel extraction system of claim 3, characterized in that the extraction line has a flexible section.

9. An auxiliary heating unit having a fuel extraction system of claim 1.

10. A motor vehicle having a fuel extraction system for an auxiliary heating unit of claim 1.

11. A method for extracting fuel for an auxiliary heating unit for the extraction of fuel from a fuel tank of a motor vehicle, characterized in that the fuel is extracted from a collecting container which is held in the fuel tank and is assigned exclusively to the auxiliary heating unit.
